(19) United States
(12) Patent Application Publication
(10) Pub. No.: US 2026/0329068 A1
(43) Pub. Date: Oct. 22, 2026

(54) LENS UNIT FOR HOLE INSPECTION

(71) Applicant: AISIN CORPORATION, Kariya, Aichi (JP)

(72) Inventor: Syotaro NAGATA, Kariya-shi, Aichi-ken (JP)

(73) Assignee: AISIN CORPORATION, Kariya, Aichi (JP)

(21) Appl. No.: 19/112,325

(22) PCT Filed: Apr. 4, 2023
(86) PCT No.: PCT/JP2023/013902

§ 371 Date: Mar. 17, 2025

(30) Foreign Application Priority Data
Oct. 25, 2022 (JP) 2022-170947

(51) Int. Cl. G02B 23/24

(52) U.S. Cl. CPC G02B 23/243; G02B 23/2469; G02B 23/2484

(57) ABSTRACT

A hole inspection lens unit including an outer tube having a tubular shape, an inner tube having a tubular shape and inserted through the outer tube, an objective lens inside a tip end of the inner tube, a mount portion supporting a base end portion of the outer tube and a base end portion of the inner tube and to which a camera that captures an image of an inside of a hole via the objective lens is attached, a light guide tube having a tubular shape disposed between the outer tube and the inner tube to surround a tip end portion of the inner tube and surrounded by a tip end portion of the outer tube, and torpedo-shaped light emitting diodes disposed inside the outer tube and around the inner tube to face an end portion of the light guide tube on a mount portion side.

### CROSS REFERENCE TO RELATED APPLICATIONS

This application is a National Stage of International Application No. PCT/JP2023/013902 filed Apr. 4, 2023, claiming priority based on Japanese Patent Application No. 2022-170947 filed Oct. 25, 2022, the entire contents of which are incorporated in their entirety.

### TECHNICAL FIELD

This disclosure relates to a hole inspection lens unit used for inspecting an inside of a hole formed in a workpiece.

### BACKGROUND ART

In the related art, a hole-inside inspection device is known which includes an inspection head and a robot that moves the inspection head away from an opening of a hole of a workpiece by a predetermined distance (for example, see PTL 1). The inspection head of the hole-inside inspection device includes a camera that captures an image of the hole of the workpiece, a wide-angle lens having an optical axis parallel to an axis of the hole of the workpiece, a relay lens implemented by combining a plurality of high-precision lenses, and a half mirror that refracts light from spot illumination (light source) to emit the light to the hole. The light from the spot illumination is refracted by the half mirror, transmitted through the relay lens and the wide-angle lens, and uniformly emitted to an inner surface of the hole. Reflected light from the hole is transmitted through the wide-angle lens, the relay lens, and the half mirror and is incident on the camera. Then, the camera captures an image of the inside of the hole from a position that is away from the opening of the hole to an outer side of the hole by a predetermined distance.

### CITATION LIST

### Patent Literature

PTL 1: JP2018-036203A

### SUMMARY OF DISCLOSURE

### Technical Problem

As described above, when the inside of the hole is imaged in a state in which the camera is separated from the opening of the hole, it is necessary to secure uniform illuminance in the entire inside of the hole by an illumination device. In order to secure the illuminance inside the hole, it is also conceivable to use, for example, a light source including, for example, optical fibers as the illumination device. However, linearity of light is strong, and thus a stripe of light may be included in the image captured by the camera.

Therefore, a main object of this disclosure is to provide a hole inspection lens unit capable of reducing noise of an image of an inside of a hole of a workpiece captured by a camera by ensuring uniform illuminance inside the hole when the camera captures the image.

### Solution to Problem

According to this disclosure, a hole inspection lens unit used for inspecting an inside of a hole formed in a workpiece includes: an outer tube having a tubular shape; an inner tube having a tubular shape and inserted through the outer tube; an objective lens disposed inside a tip end of the inner tube; a mount portion that supports a base end portion of the outer tube and a base end portion of the inner tube and to which a camera that captures an image of the inside of the hole via the objective lens is attached; a light guide tube having a tubular shape and disposed between the outer tube and the inner tube so as to surround a tip end portion of the inner tube while being surrounded by a tip end portion of the outer tube; and a plurality of torpedo-shaped light emitting diodes disposed inside the outer tube and around the inner tube so as to face an end portion of the light guide tube on a mount portion side.

When the inside of the hole formed in the workpiece is imaged by the camera using the hole inspection lens unit according to this disclosure, the lens unit in which the camera is attached to the mount portion is kept stationary such that the objective lens is positioned above the hole. Further, each of the torpedo-shaped light emitting diodes emits light. The torpedo-shaped light emitting diodes are excellent in light collecting property, and the light emitted from each torpedo-shaped light emitting diode is emitted while being diffused into the inside of the hole via the light guide tube having a tubular shape. Accordingly, it is possible to reduce noise of the image of the inside of the hole of the workpiece captured by the camera by ensuring uniform illuminance inside the hole when the camera captures the image.

### BRIEF DESCRIPTION OF DRAWINGS

FIG. 1 is a schematic configuration diagram illustrating a hole inspection system to which a hole inspection lens unit disclosed here is applied

FIG. 2 is a cross-sectional view illustrating the hole inspection lens unit disclosed here.

### DESCRIPTION OF EMBODIMENTS

Next, an embodiment for implementing this disclosure will be described with reference to the drawings.

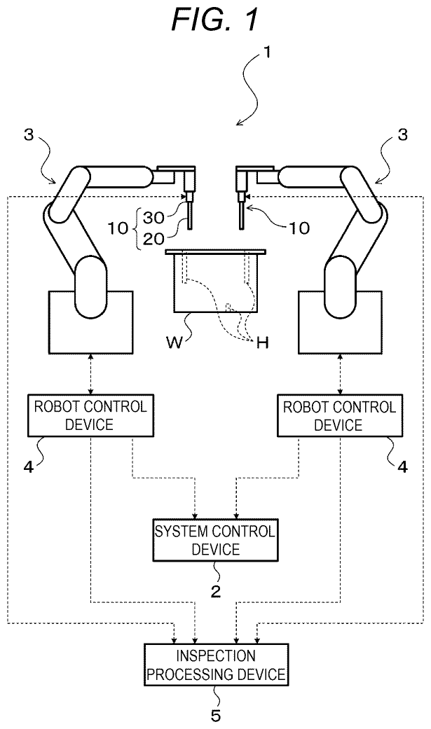

FIG. 1 is a schematic configuration diagram illustrating a hole inspection system 1 to which a hole inspection lens unit (hereinafter, simply referred to as a “lens unit”) 20 disclosed here is applied. The hole inspection system 1 illustrated in FIG. 1 is used for inspecting an inside of a hole H formed in a workpiece W such as a case of a transmission. The hole H to be inspected may be a screw hole, a non-screw hole, a through hole, or a non-through hole. The workpiece W is not limited to the case of the transmission.

As illustrated in FIG. 1, the hole inspection system 1 includes a system control device 2, a plurality of robots 3, a plurality of robot control devices 4 that are connected to the system control device 2 and control the corresponding robots 3, and an inspection processing device 5 connected to the system control device 2. The system control device 2 includes a computer including a CPU, a ROM, a RAM, and the like, and comprehensively controls the hole inspection system 1 by exchanging signals (information) with the plurality of robot control devices 4 and the inspection processing device 5. Each of the robots 3 is a robot arm capable of holding and moving an imaging tool 10 including a lens unit 20 and a camera 30. Further, each of the robot control devices 4 includes a computer including a CPU, a ROM, a RAM, and the like, and controls the corresponding robot 3 so as to move the imaging tool 10 to an inspection work position above the hole H to be inspected by a predetermined distance according to a predetermined control procedure.

The inspection processing device 5 is a computer including a CPU, a ROM, a RAM, and the like. The camera 30 of the imaging tool 10 is connected to the inspection processing device 5 via a connector, a cable, or the like provided in the robot 3. Further, an inspection program for inspecting a state inside the hole H based on an image (image data) of the inside of the hole H captured by the camera 30 is installed in the inspection processing device 5. The inspection program (software) cooperates with hardware such as the CPU, the ROM, or the RAM of the inspection processing device 5 to implement, for example, a neural network that determines (diagnoses) the state inside the hole H based on the image captured by the camera 30.

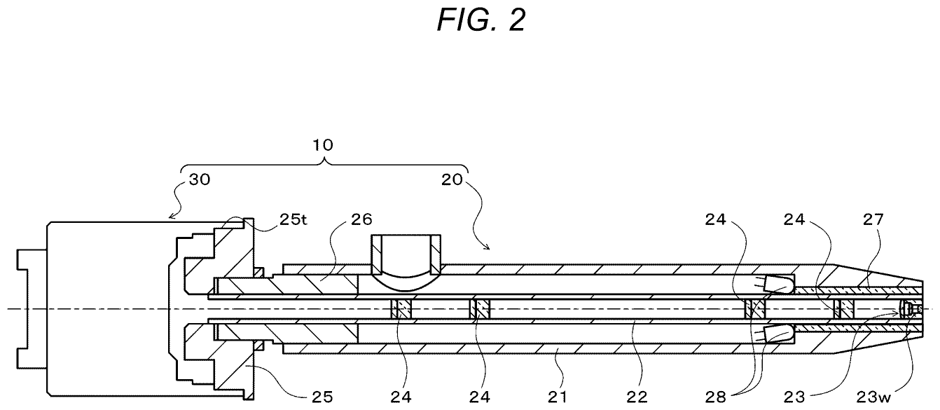

FIG. 2 is a longitudinal cross-sectional view illustrating the lens unit 20. As illustrated in FIG. 2, the lens unit 20 includes an outer tube 21, an inner tube 22, an objective lens portion 23, a plurality of relay lenses 24, a mount portion 25 to which the camera 30 is attached, a retainer 26, a light guide tube 27, and a plurality of (for example, six in the present embodiment) torpedo-shaped light emitting diodes 28.

The outer tube 21 is formed in a cylindrical shape and is made of a material having a light shielding property such as metal, and a tip end portion of the outer tube 21 is tapered. The inner tube 22 is formed in a cylindrical shape having an outer diameter smaller than an inner diameter of the outer tube 21, and is made of a material having a light shielding property such as metal (for example, stainless steel). The inner tube 22 is coaxially inserted through the outer tube 21, and is fixed to a base end portion of the outer tube 21 via the retainer 26. The objective lens portion 23 includes a wide-angle lens 23w and is disposed (fixed) inside a tip end of the inner tube 22. The plurality of relay lenses 24 are disposed at intervals inside the inner tube 22 so as to relay an image from the wide-angle lens 23w to the camera 30 attached to the mount portion 25.

The mount portion 25 is fixed to the retainer 26 and supports the base end portion of the outer tube 21 and a base end portion of the inner tube 22 via the retainer 26. A male screw 25t conforming to a C-mount standard is formed on an outer peripheral surface of the mount portion 25. Accordingly, various industrial cameras conforming to the C-mount standard can be attached to the mount portion 25. Further, an industrial camera conforming to a CS-mount standard can also be attached to the mount portion 25 via an adapter.

The light guide tube 27 is formed in a relatively short cylindrical shape, is made of glass, quartz, or the like, and has an outer diameter slightly smaller than the inner diameter of the outer tube 21 and an inner diameter slightly larger than the outer diameter of the inner tube 22. The light guide tube 27 is fitted to an inside of the tip end portion of the outer tube 21 and a tip end portion of the inner tube 22 is fitted to an inside of the light guide tube 27. Accordingly, the light guide tube 27 is disposed between the outer tube 21 and the inner tube 22 so as to surround the tip end portion of the inner tube 22 while being surrounded by the tip end portion of the outer tube 21. In addition, the plurality of torpedo-shaped light emitting diodes 28 are disposed at intervals (at equal intervals) inside the outer tube 21 and around the inner tube 22 so as to face (abut) an end portion of the light guide tube 27 on a mount portion 25 side. The cable (not illustrated) connected to the torpedo-shaped light emitting diodes 28 is pulled out to an outside of the outer tube 21 via a space between the outer tube 21 and the inner tube 22, and is connected to an illumination power supply (not illustrated) via a connector.

When the inside of the hole H formed in the workpiece W is imaged by the camera 30 using the lens unit 20 having configured as described above, the imaging tool 10, that is, the lens unit 20 in which the camera 30 is attached to the mount portion 25 is moved by the robot 3 such that the objective lens portion 23 (wide-angle lens 23w) is positioned above the hole H by a predetermined distance, and is kept stationary at the inspection work position. Further, each of the torpedo-shaped light emitting diodes 28 emits light. The torpedo-shaped light emitting diodes 28 are excellent in light collecting property, and the light emitted from each torpedo-shaped light emitting diode 28 is emitted while being diffused into the inside of the hole H via the light guide tube 27 having a cylindrical shape. Accordingly, it is possible to secure uniform illuminance inside the hole H when the camera 30 captures the image of the inside of the hole H of the workpiece W, and to fairly and favorably reduce noise such as a stripe of light in the image captured by the camera 30.

In the mount portion 25 of the lens unit 20, the male screw 25t conforming to the C-mount standard as a typical standard of an industrial camera is formed. Accordingly, since a plurality of industrial cameras having different specifications such as the number of pixels can be attached to the mount portion 25, the inside of the hole H can be imaged using the camera 30 suitable for the hole H to be imaged. Further, the objective lens portion 23 of the lens unit 20 includes the wide-angle lens 23w, and the plurality of relay lenses 24 are disposed inside the inner tube 22. Accordingly, the entire inside of the hole H can be focused. Further, by disposing the plurality of relay lenses 24 inside the inner tube 22, it is possible to determine an axial length of the lens unit 20 according to a shape of the workpiece W. For example, it is possible to increase the axial length of the lens unit 20 for imaging the inside of the hole H formed in a bottom portion of the workpiece W. Depending on the axial length required for the lens unit 20, a single relay lens 24 may be disposed in the inner tube 22, and the relay lens 24 may be omitted.

As described above, according to this disclosure, a hole inspection lens unit (20) used for inspecting an inside of a hole (H) formed in a workpiece (W) includes: an outer tube (21) having a tubular shape; an inner tube (22) having a tubular shape and inserted through the outer tube (21); an objective lens (23, 23w) disposed inside a tip end of the inner tube (22); a mount portion (25) that supports a base end portion of the outer tube (21) and a base end portion of the inner tube (22) and to which a camera (30) that captures an image of the inside of the hole (H) via the objective lens (23, 23w) is attached; a light guide tube (27) having a tubular shape and disposed between the outer tube (21) and the inner tube (22) so as to surround a tip end portion of the inner tube (22) while being surrounded by a tip end portion of the outer tube (21); and a plurality of torpedo-shaped light emitting diodes (28) disposed inside the outer tube (21) and around the inner tube (22) so as to face an end portion of the light guide tube (27) on a mount portion (25) side.

When the inside of the hole formed in the workpiece is imaged by the camera using the hole inspection lens unit according to this disclosure, the lens unit in which the camera is attached to the mount portion is kept stationary such that the objective lens is positioned above the hole. Further, each of the torpedo-shaped light emitting diodes emits light. The torpedo-shaped light emitting diodes are excellent in light collecting property, and the light emitted from each torpedo-shaped light emitting diode is emitted while being diffused into the inside of the hole via the light guide tube having a tubular shape. Accordingly, it is possible to reduce noise in the image of the inside of the hole of the workpiece captured by the camera by ensuring uniform illuminance inside the hole when the camera captures the image.

A male screw (25t) conforming to a C-mount standard is formed in the mount portion (25).

Accordingly, since a plurality of cameras having different specifications such as the number of pixels can be attached to the mount portion, the inside of the hole can be imaged using the camera suitable for the hole to be imaged.

Further, the objective lens may be a wide-angle lens (23w), and at least one relay lens (24) is disposed inside the inner tube (22).

Accordingly, the entire inside of the hole can be focused, and it is possible to determine an axial length of the lens unit according to a shape of the workpiece.

Each of the plurality of torpedo-shaped light emitting diodes (28) abuts the end portion of the light guide tube (27) on the mount portion (25) side.

It is needless to say that this disclosure is not limited to the embodiment described above, and various modifications can be made without departing from the scope of this disclosure. Further, the embodiment described above is merely a specific aspect according to this disclosure described in the SUMMARY, and does not limit elements according to this disclosure described in the SUMMARY.

### Industrial Applicability

This disclosure is fairly useful for inspecting an inside of a hole formed in a workpiece in manufacturing industries.

1. A hole inspection lens unit used for inspecting an inside of a hole formed in a workpiece, the hole inspection lens unit comprising:
an outer tube having a tubular shape;
an inner tube having a tubular shape and inserted through the outer tube;
an objective lens disposed inside a tip end of the inner tube;
a mount portion that supports a base end portion of the outer tube and a base end portion of the inner tube and to which a camera that captures an image of the inside of the hole via the objective lens is attached;
a light guide tube having a tubular shape and disposed between the outer tube and the inner tube so as to surround a tip end portion of the inner tube while being surrounded by a tip end portion of the outer tube; and
a plurality of torpedo-shaped light emitting diodes disposed inside the outer tube and around the inner tube so as to face an end portion of the light guide tube on a mount portion side.

2. The hole inspection lens unit according to claim 1, wherein
a male screw conforming to a C-mount standard is formed in the mount portion.

3. The hole inspection lens unit according to claim 1, wherein
the objective lens is a wide-angle lens, and at least one relay lens is disposed inside the inner tube.

4. The hole inspection lens unit according to claim 1, wherein
each of the plurality of torpedo-shaped light emitting diodes abuts the end portion of the light guide tube on the mount portion side.
